(19) United States
(12) Patent Application Publication
(10) Pub. No.: US 2014/0338639 A1
(43) Pub. Date: Nov. 20, 2014

(54) METHOD OF CONTROLLING INJECTION RATE SHAPE OF GASEOUS FUEL IN DUAL FUEL INJECTOR

(71) Applicant: Caterpillar Inc., Peoria, IL (US)

(72) Inventor: Cory A. Brown, Peoria, IL (US)

(73) Assignee: Caterpillar Inc., Peoria, IL (US)

(21) Appl. No.: 14/291,657

(22) Filed: May 30, 2014

(51) Int. Cl. F02D 19/06

(52) U.S. Cl. CPC F02D 19/0694; F02D 19/0642
USPC 123/445

(57) ABSTRACT

A method of controlling injection rate shape of gaseous fuel in a dual fuel injector of an engine is disclosed. The dual fuel injector comprises a gaseous fuel needle check, a gaseous fuel control chamber, and a spring chamber. The method includes determination of an injection rate shape based on current operational characteristics of the engine. On the basis of the determined injection rate shape, liquid fuel pressure of the liquid fuel to be supplied to the gaseous fuel control chamber and the spring chamber is determined. The liquid fuel at the determined liquid fuel pressure, is delivered to the gaseous fuel control chamber and the spring chamber. The gaseous fuel needle check is lifted to inject the gaseous fuel based on the determined injection rate shape.

### TECHNICAL FIELD

The present disclosure generally relates to dual fuel injectors. More specifically, the present disclosure relates to method of controlling injection rate shape of gaseous fuel in dual fuel injector.

### BACKGROUND

Internal combustion engines have been used to drive machines. The internal combustion engines have undergone improvements to become more powerful, more efficient, and/or produce fewer emissions. One way this may be achieved, is through improvement in the fuel qualities. Gaseous fuels, such as methane, hydrogen, natural gas, or blends of such fuels have also been introduced. As compared to liquid fuels, gaseous fuels may produce more favorable emissions during combustion. However, the gaseous fuels may not ignite as easily, or at the same rate as that of the liquid fuels, which may cause problems. Therefore, a dual fuel engine may be used in which a mixture of the liquid fuel such as, diesel fuel, and the gaseous fuel such as, natural gas, may be injected into a combustion chamber of the internal combustion engine. The diesel fuel may initiate combustion inside the combustion chamber of the dual fuel engine, and the gaseous fuel may thus be ignited.

The dual fuel engine may use a dual fuel injector. In the dual fuel injector, the gaseous fuel may be injected at a predefined injection rate shape. The injection rate shape of gaseous fuel may be defined as a rate of rise in injection pressure of the gaseous fuel. The injection rate shape of the gaseous fuel may be constant throughout the injection event, in various previously known dual fuel injectors. A constant injection rate shape of the gaseous fuel may result in low fuel economy, high emissions, particulate problems, and reduced efficiency of the dual fuel engines.

### SUMMARY OF THE DISCLOSURE

The present disclosure is related to a method of controlling injection rate shape of a gaseous fuel in a dual fuel injector of an engine. The dual fuel injector comprises a gaseous fuel needle check, a gaseous fuel control chamber, and a spring chamber. The interaction between liquid fuel pressure in the gaseous fuel control chamber and the liquid fuel pressure in the spring chamber, controls lifting of the gaseous needle check.

According to the present disclosure, the method of controlling injection rate shape of the gaseous fuel includes determination of the injection rate shape, based on current operational characteristics of the engine. Based on the determined injection rate shape, liquid fuel pressure of the liquid fuel to be supplied to the gaseous fuel control chamber and the spring chamber, is determined. The liquid fuel at the determined liquid fuel pressure, is delivered to the gaseous fuel control chamber and the spring chamber so as to achieve the determined injection rate shape. The gaseous fuel needle check is lifted to inject the gaseous fuel based on the determined injection rate shape.

### BRIEF DESCRIPTION OF THE DRAWINGS

FIG. 1 illustrates a schematic of an engine system, in accordance with the concepts of the present disclosure;

FIG. 2 illustrates a dual fuel injector of the engine system of FIG. 1, in accordance with the concepts of the present disclosure; and

FIG. 3 illustrates a flow chart for a method of controlling gaseous fuel injection rate shape of the dual fuel injector of FIG. 2, in accordance with the concepts of the present disclosure.

### DETAILED DESCRIPTION

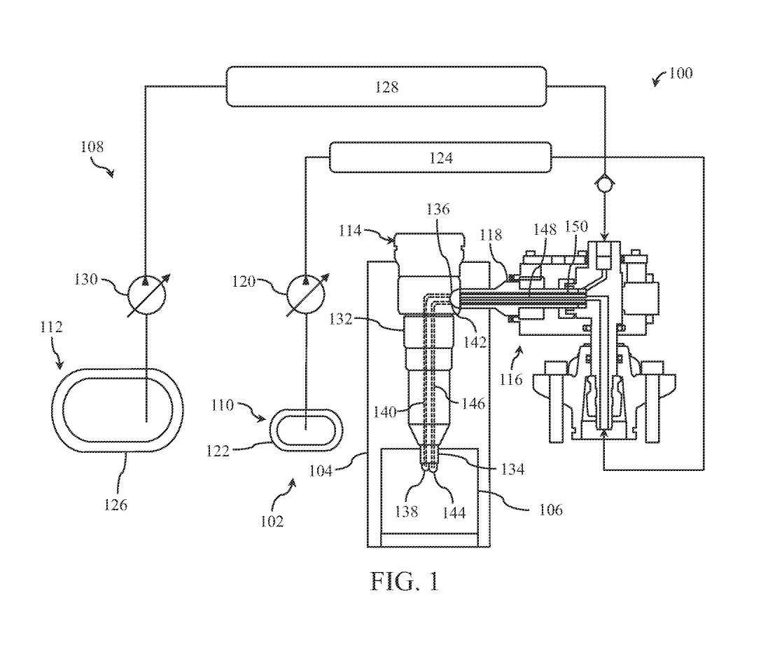

Referring to FIG. 1, there is shown an engine system 100 including an engine 102. The engine 102 may include a housing 104 having a cylinder 106 therein. The engine system 100 further includes a dual fuel system 108.

Further, the dual fuel system 108 may include a liquid fuel supply 110, a gaseous fuel supply 112, a dual fuel injector 114, a fuel connector 116, and a quill connector 118. The liquid fuel supply 110 may include a first pressurizing mechanism 120, a liquid fuel tank 122, and a liquid fuel common rail 124. The first pressurizing mechanism 120 may be fluidly connected with the liquid fuel tank 122. In an embodiment, the first pressurizing mechanism 120 may be a pump. The first pressurizing mechanism 120 may pressurize liquid fuel, such as, petroleum distillate diesel fuel, from the liquid fuel tank 122, and convey the same to the liquid fuel common rail 124.

The gaseous fuel supply 112 may include a gaseous fuel tank 126, a gaseous fuel common rail 128, and a second pressurizing mechanism 130. The gaseous fuel tank 126 may be configured to store a liquefied gaseous fuel, such as, natural gas, or the like. The second pressurizing mechanism 130 may be configured to pressurize the gaseous fuel and supply the same to the gaseous fuel common rail 128. Various parts of system, such as the first pressurizing mechanism 120 and the second pressurizing mechanism 130 may be electronically controlled. Also, a conventional electronic control module, along with various sensors and communication lines might be used to vary an output of the first pressurizing mechanism 120 and the second pressurizing mechanism 130. The output of the first pressurizing mechanism 120 and the second pressurizing mechanism 130 may be used to control the fuel pressures within the liquid fuel common rail 124 and the gaseous fuel common rail 128, respectively.

Further, the dual fuel system 108 includes the dual fuel injector 114, which may be coupled with the housing 104. The dual fuel injector 114 may include an injector body 132. The injector body 132 may further include a tip piece 134, a liquid fuel inlet 136, a liquid fuel nozzle 138, a liquid fuel supply passage 140, a gaseous fuel inlet 142, a gaseous fuel nozzle 144, and a gaseous fuel supply passage 146. The liquid fuel inlet 136 may receive the liquid fuel, from the liquid fuel common rail 124. Thereafter, the liquid fuel from the liquid fuel inlet 136 may be supplied to the liquid fuel nozzle 138 at a first fuel pressure, via the liquid fuel supply passage 140.

As discussed above, the injector body 132 may further define the gaseous fuel inlet 142, which may receive pressurized gaseous fuel from the gaseous fuel common rail 128. The pressurized gaseous fuel may then be supplied from the gaseous fuel inlet 142 to the gaseous fuel nozzle 144, at a second fuel pressure, via the gaseous fuel supply passage 146. The second fuel pressure may be different from the first fuel pressure.

Each of the liquid fuel nozzle 138 and the gaseous fuel nozzle 144 is formed in the tip piece 134 and may include a plurality of spray orifices (not shown). The liquid fuel nozzle 138 and the gaseous fuel nozzle 144 may be vertically offset from one another in the cylinder 106. A variety of internal components of the dual fuel injector 114, which may be electronically controlled, are used to control the opening and closing of the liquid fuel nozzle 138 and the gaseous fuel nozzle 144, in a manner further described herein.

The dual fuel system 108 may further include the fuel connector 116 configured to fluidly connect the liquid fuel common rail 124 and the gaseous fuel common rail 128, with the dual fuel injector 114. In a practical implementation strategy, the dual fuel system 108 may include the quill connector 118, which may have a first fluid conduit 148 and a second fluid conduit 150. The first fluid conduit 148 may fluidly connect the liquid fuel inlet 136 with the liquid fuel common rail 124. Similarly, the second fluid conduit 150 may fluidly connect the gaseous fuel inlet 142 with the gaseous fuel common rail 128. As noted above, the engine 102 may include a plurality of cylinders, and it will thus be readily apparent that the engine 102 may also include a plurality of dual fuel injectors, associated one with each of the plurality of cylinders. Each cylinder may have a fuel connector similar to the fuel connector 116, which may have a design known in the art. Hence, separate fluid connectors might be used between each of the liquid fuel common rail 124 and the gaseous fuel common rail 128, and the dual fuel injector 114 in other embodiments.

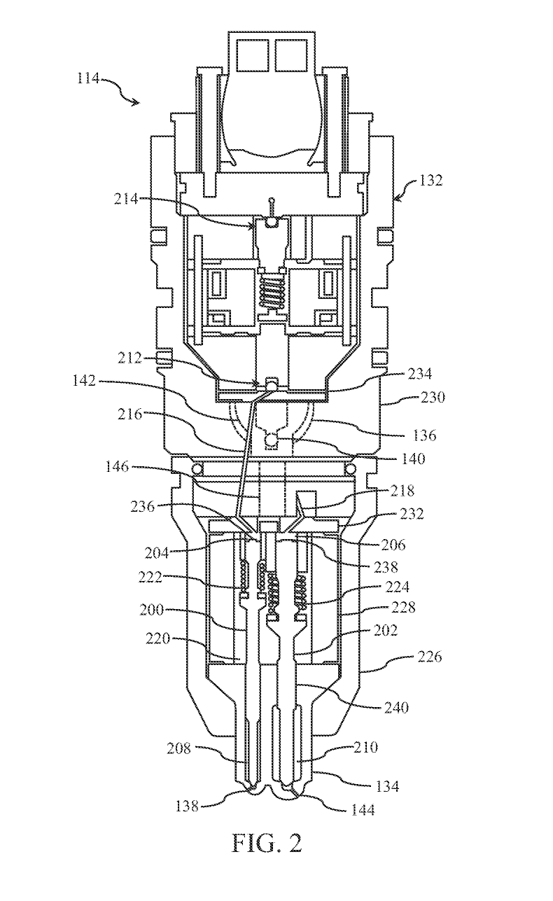

Referring to FIG. 2, there are shown additional details of the dual fuel injector 114. As discussed above in the description of FIG. 1, the dual fuel injector 114 includes the injector body 132, the tip piece 134, the liquid fuel inlet 136, the gaseous fuel inlet 142, the liquid fuel supply passage 140, the gaseous fuel supply passage 146, the gaseous fuel nozzle 144, and the liquid fuel nozzle 138. Further, the dual fuel injector 114 may include a liquid fuel needle check 200, a gaseous fuel needle check 202, a liquid fuel control chamber 204, a gaseous fuel control chamber 206, a liquid fuel collection chamber 208, a gaseous fuel collection chamber 210, a liquid fuel injection control valve 212, a gaseous fuel injection control valve 214, a first drain line 216, a second drain line 218, a spring chamber 220, a first spring 222, and a second spring 224.

Apart from the tip piece 134 shown and discussed in FIG. 1, the injector body 132 may include a plurality of body pieces, such as, an outer body piece 226, an inner body piece 228, an upper body piece 230, and an orifice plate 232. The tip piece 134 may be positioned within the outer body piece 226. The outer body piece 226 may be threadedly coupled with the upper body piece 230, in a way, such that the upper body piece 230 may be rotated to clamp together the internal components of the dual fuel injector 114. The injector body 132 may also include the orifice plate 232, which may be clamped between the upper body piece 230 and the tip piece 134.

Further, the injector body 132 may define the liquid fuel control chamber 204, the gaseous fuel control chamber 206, and a low pressure space 234. Each of the liquid fuel control chamber 204 and the gaseous fuel control chamber 206 may be in fluid communication with the liquid fuel inlet 136. In other words, the liquid fuel control chamber 204 and the gaseous fuel control chamber 206 may be supplied with the liquid fuel, via the liquid fuel supply passage 140. Pressure of the liquid fuel in the liquid fuel control chamber 204 and the gaseous fuel control chamber 206, is typically the fuel pressure of the liquid fuel common rail 124. A pressure gradient between the liquid fuel control chamber 204 and the low pressure space 234 may enable injection of the liquid fuel. Similarly, a pressure gradient between the gaseous fuel control chamber 206 and the low pressure space 234 may enable injection of the gaseous fuel.

The injector body 132 may house the liquid fuel needle check 200 having a first open surface 236, which may be exposed to fuel pressure of the liquid fuel supply passage 140. The liquid fuel needle check 200 is movable within the injector body 132 to open and close the liquid fuel nozzle 138. The liquid fuel check may control injection of the liquid fuel, which is collected in the liquid fuel collection chamber 208. The liquid fuel may be drained from the spring chamber 220 to the liquid fuel collection chamber 208, in a controlled manner which will be described herein.

The injector body 132 may also house the gaseous fuel needle check 202, which may be positioned side-by-side, and typically parallel with liquid fuel needle check 200. The gaseous fuel needle check 202 may include a second open surface 238, which may be exposed to the fuel pressure of the liquid fuel supply passage 140. The gaseous fuel needle check 202 may be movable within the injector body 132 to open and close the gaseous fuel nozzle 144. The gaseous fuel needle check 202 may lift to open the gaseous fuel nozzle 144, allowing injection of the gaseous fuel, which may be collected in the gaseous fuel collection chamber 210. The gaseous fuel collection chamber 210 may receive the gaseous fuel via the gaseous fuel supply passage 146.

The injector body 132 also includes the spring chamber 220. The spring chamber 220 may receive the liquid fuel from the liquid fuel supply passage 140, typically, at the fuel pressure of the liquid fuel common rail 124. The spring chamber 220 may have the first spring 222 and the second spring 224 positioned therein. The spring chamber 220 may also partially house the liquid fuel needle check 200 and the gaseous fuel needle check 202. The spring chamber 220 forms a segment of the liquid fuel supply passage 140, and thus may convey the liquid fuel from the liquid fuel inlet 136 to the liquid fuel collection chamber 208, past a clearance between the liquid fuel needle check 200 and the tip piece 134. The liquid fuel needle check 200 may be shaped to form grooves (not shown) for the flow of fuel past a portion of the liquid fuel needle check 200 within the tip piece 134. The gaseous fuel collection chamber 210, however, will typically be blocked from substantial fluid communication with the spring chamber 220. For the purpose of blocking the fluid communication between the gaseous fuel collection chamber 210 and the spring chamber 220, the gaseous fuel needle check 202 may include a guide segment 240 having a match clearance with a bore 242 formed in the tip piece 134. Also, the liquid fuel intruding into the match clearance from the spring chamber 220 prevents migration of the gaseous fuel from the gaseous fuel collection chamber 210 to the spring chamber 220.

The injector may house the liquid fuel injection control valve 212 and the gaseous fuel injection control valve 214. The liquid fuel injection control valve 212 and the gaseous fuel injection control valve 214, respectively, may be positioned to fluidly connect the liquid fuel control chamber 204 and the gaseous fuel control chamber 206, with the low pressure space 234. The liquid fuel injection control valve 212 may be fluidly connected with the liquid fuel control chamber 204, via the first drain line 216. The first drain line 216 may be actuated to reduce a fuel pressure in the liquid fuel control chamber 204, by draining the liquid fuel from the liquid fuel control chamber 204. At this point, the fuel pressure in the liquid fuel control chamber 204 may decrease and hydraulic force acting on the first open surface 236 may be reduced. This creates a pressure difference between the fuel pressure in the liquid fuel control chamber 204 and the fuel pressure in the spring chamber 220, thereby enabling the liquid fuel needle check 200 to lift and open the liquid fuel nozzle 138.

Similarly, the gaseous fuel injection control valve 214 may be fluidly connected with the gaseous fuel control chamber 206, via the second drain line 218. The second drain line 218 may be actuated to reduce the fuel pressure in the gaseous fuel control chamber 206, by draining the liquid fuel from the gaseous fuel control chamber 206. At this point, the fuel pressure in the gaseous fuel control chamber 206 may decrease and hydraulic force acting on the second open surface 238 may be reduced. This creates a pressure difference between the fuel pressure in the gaseous fuel control chamber 206 and the fuel pressure in the spring chamber 220, thereby enabling the gaseous fuel needle check 202 to lift and open the gaseous fuel nozzle 144. Lifting of the liquid fuel needle check 200 and the gaseous fuel needle check 202, may occur as a result of opposition to biasing action of a first spring 222 and a second spring 224, respectively. In order to end injection, the liquid fuel injection control valve 212 and the gaseous fuel injection control valve 214, respectively, may be deactivated, either energized or de-energized as the case may be, to restore the fuel pressure in the liquid fuel control chamber 204 and the gaseous fuel control chamber 206, to a pressure of the liquid fuel common rail 124. In closed position, the first spring 222 and the second spring 224, respectively, may bias the liquid fuel needle check 200 and the gaseous fuel needle check 202, against the fuel pressure in the liquid fuel control chamber 204 and the gaseous fuel control chamber 206.

The gaseous fuel nozzle 144 may allow injection of the gaseous fuel, at a predefined injection rate shape. The injection rate shape of the gaseous fuel is the rate of increase in injection pressure of the gaseous fuel during an injection event. The injection rate shape of the gaseous fuel is determined by the controller and is based on current operational characteristics of the engine 102. Based on the determined injection rate shape, a controller (not shown) determines a fuel pressure, at which the liquid fuel is to be supplied to the dual fuel injector 114, and hence to the gaseous fuel control chamber 206 and the spring chamber 220. The fuel pressure of the liquid fuel, supplied to the dual fuel injector 114 may be modulated by the controller (not shown). Thus, it is the interaction of liquid fuel pressure in the spring chamber 220 with the gaseous fuel pressure in the gaseous fuel collection chamber 210 and the liquid fuel pressure in the gaseous fuel control chamber 206, which allows attaining the determined injection rate shape of the gaseous fuel.

In an embodiment, the engine 102 may function at an operational characteristic of 50% load and that the maximum pressure for a gaseous fuel injection is 35 MPa. The operational characteristic of the engine 102 may be speed variation, acceleration variation, load variation, and/or the like. The gaseous fuel is supplied to the gaseous fuel collection chamber 210, via the gaseous fuel supply passage 146. The controller (not shown) may determine that a ramped injection rate shape is required for injection of the gaseous fuel. The ramped injection rate shape is an injection rate shape when the gaseous fuel is injected at an injection pressure linearly increasing with time during the injection event. In an embodiment, the controller (not shown) may have a set of pre-determined injection rate shapes corresponding to different operational characteristics.

Thereafter, the controller (not shown) may determine that the liquid fuel be supplied to the gaseous fuel control chamber 206 and the spring chamber 220, at the liquid fuel pressure of 40 MPa, so as to achieve the ramped injection rate shape. For gaseous fuel injection, the gaseous fuel injection control valve 214 may be actuated to open the second drain line 218. The liquid fuel is drained from the gaseous fuel control chamber 206, through the second drain line 218. Hence, the liquid fuel pressure in the gaseous fuel control chamber 206 decreases below 40 MPa. The liquid fuel pressure in the gaseous fuel control chamber 206 is lower than the liquid fuel pressure in the spring chamber 220. In other words, the interaction between the reduced liquid fuel pressure in the gaseous fuel control chamber 206 and the liquid fuel pressure (40 MPa) in the spring chamber 220 causes the gaseous fuel needle check 202 to lift. Gaseous pressure in the gaseous fuel collection chamber 210 also contributes to the upward force which moves the gaseous fuel needle check 202, thereby making the net upward force high. Therefore, the gaseous fuel needle check 202 lifts with a rate of lifting so as to attain the ramped injection rate shape.

Now, the operational characteristics of the engine 102 may change at times. For example, the engine 102 may start operating at 100% load and that the maximum pressure for the gaseous fuel injection be 35 MPa. At 100% load, the controller (not shown) may determine that the gaseous fuel is to be injected at a square rate shape. At the square rate shape, the gaseous fuel is injected at same injection pressure, that is, 35 MPa, throughout the injection event. Thereafter, the controller (not shown) may determine that to achieve the square rate shape, the liquid fuel be supplied to the gaseous fuel control chamber 206, at the liquid fuel pressure of 75 MPa. The controller (not shown) may actuate the gaseous fuel injection control valve 214, for the gaseous fuel injection. The gaseous fuel injection control valve 214 is actuated to open the second drain line 218. The liquid fuel is drained from the gaseous fuel control chamber 206 through the second drain line 218, thereby decreasing the liquid fuel pressure in the gaseous fuel control chamber 206 and the spring chamber 220 below 75 MPa.

As the liquid fuel drains through the second drain line 218, the liquid fuel pressure in the gaseous fuel control chamber 206 falls below 75 MPa. Hence, the liquid fuel pressure (75 MPa) in the spring chamber 220 becomes greater than the liquid fuel pressure in the gaseous fuel control chamber 206. In this condition, the gaseous fuel control chamber 206 is at a pressure lower than 75 MPa, so there is low force acting on the second open surface 238. The gaseous fuel needle check 202 moves vertically upward with an upward force proportional to the 75 MPa liquid pressure. Gaseous pressure in the gaseous fuel collection chamber 210 also contributes to the upward force which moves the gaseous fuel needle check 202, thereby making the net upward force high. Therefore, the gaseous fuel needle check 202 lifts with a rate of lifting so as to attain the square rate shape.

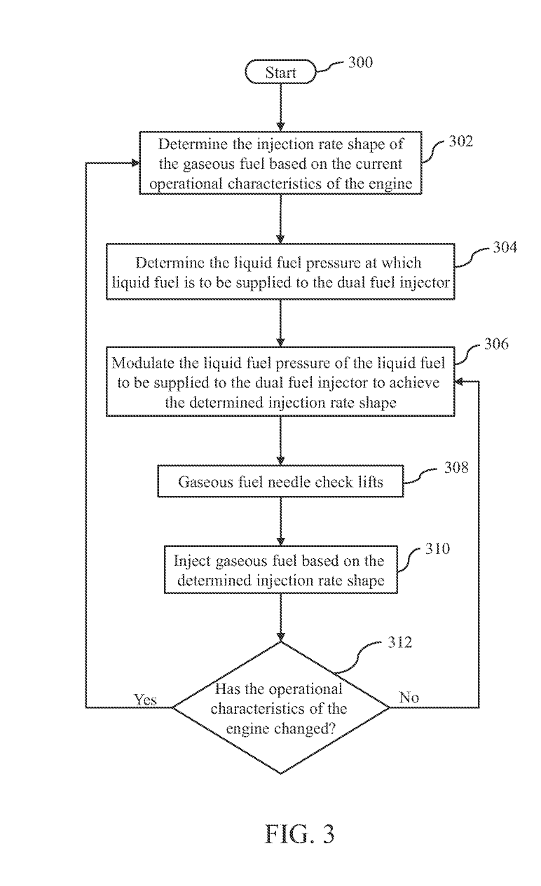

Referring to FIG. 3, there is shown a flow chart for the method of controlling the injection rate shape of the gaseous fuel. The method starts at step 300 and proceeds to step 302.

At step 302, the injection rate shape of the gaseous fuel is determined, based on the current operational characteristics of the engine 102. The method proceeds to step 304.

At step 304, the controller (not shown) determines the liquid fuel pressure, at which the liquid fuel be supplied to the dual fuel injector 114, that is, to the gaseous fuel control chamber 206 and the spring chamber 220. The determined liquid fuel pressure is based on the determined injection rate shape. The method proceeds to step 306.

At step 306, the controller (not shown) modulates the liquid fuel pressure of the liquid fuel, to be supplied to the dual fuel injector 114, to control the rate of lifting of the gaseous fuel needle check 202 in order to achieve the determined injection rate shape. The liquid fuel at the determined liquid fuel pressure is supplied to the dual fuel injector 114. Hence, this implies that the gaseous fuel control chamber 206 and the spring chamber 220 receive the liquid fuel at the determined liquid fuel pressure. The method proceeds to step 308.

At step 308, due to drain of the liquid fuel from the gaseous fuel control chamber 206 through the second drain line 218, the liquid fuel pressure in the gaseous fuel control chamber 206 reduces. The liquid fuel pressure in the spring chamber 220 becomes greater than the liquid fuel pressure in the gaseous fuel control chamber 206, and the gaseous fuel needle check 202 lifts. The method proceeds to step 310.

At step 310, as the gaseous fuel needle check 202 lifts, the gaseous fuel is injected in the combustion chamber through the gaseous fuel nozzle 144. The gaseous fuel is injected in the injection rate shape determined by the controller (not shown). The method proceeds to step 312.

At step 312, the controller (not shown) checks to determine if there is a change in the current operational characteristics of the engine 102. If there is a change in the current operational characteristics of the engine 102, the method returns to step 302. If there is no change in the current operational characteristics of the engine 102, the method returns to step 306.

### INDUSTRIAL APPLICABILITY

According to the disclosed method of controlling injection rate shape of the gaseous fuel, the injection rate shape of the gaseous fuel in the combustion chamber is controlled by supplying the liquid fuel at the determined liquid fuel pressure, to the dual fuel injector 114. In other words, the injection rate shape of the gaseous fuel can be changed by adjusting or changing the liquid fuel pressure of the liquid fuel, supplied to the dual fuel injector 114. Change in the injection rate shape is based on the change in the operational characteristics of the engine 102. The controller (not shown) determines the required injection rate shape for the current operational characteristics of the engine 102. The controller (not shown) then determines the required liquid fuel pressure of the liquid fuel, to be supplied to the dual fuel injector 114, based on the determined injection rate shape. The controller (not shown) may adjust the liquid fuel pressure of the liquid fuel, delivered to the dual fuel injector 114, and hence to the gaseous fuel control chamber 206 and the spring chamber 220, to lift the gaseous fuel needle check 202. The interaction of the liquid fuel pressure in the spring chamber 220 with the liquid fuel pressure in the gaseous fuel control chamber 206 and the gaseous fuel pressure in the gaseous fuel collection chamber 210, controls rate of lift of the gaseous fuel needle check 202. Similarly, when the operational characteristics of the engine 102 change, the rate of opening and/or closing of the gaseous fuel needle check 202 are controlled for a changed injection rate shape, as determined by the controller (not shown). The changed injection rate shape is based on the changed operational characteristics of the engine 102. The changed injection rate shape is controlled by modulating the liquid fuel pressure of the liquid fuel, supplied to the dual fuel injector 114. Therefore, the liquid fuel pressure of the liquid fuel in the dual fuel injector 114 is adjusted, corresponding to variation in the operational characteristics of the engine 102, such as speed variation, acceleration variation, load variation, and/or the like.

The disclosed method of controlling injection rate shape of the gaseous fuel has an advantage as compared to existing methods of controlling the injection rate shape. The advantage is that the injection rate shape of the gaseous fuel can be changed depending on the operational characteristics of the engine 102. With existing methods of control, the gaseous fuel is injected at the same injection rate shape for different operational characteristics. The advantage discussed above is beneficial to improve fuel economy, reduction of emissions, and elimination of particulate matter.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claim.

What is claimed is:

1. A method of controlling injection rate shape of a gaseous fuel in a dual fuel injector of an engine, the dual fuel injector comprises a gaseous fuel needle check, a gaseous fuel control chamber, and a spring chamber, wherein interaction between liquid fuel pressure in the gaseous fuel control chamber and the liquid fuel pressure of the spring chamber controls lifting of the gaseous fuel needle check, the method comprising the steps of:
determining an injection rate shape based on current operational characteristics of the engine;
determining the liquid fuel pressure at which liquid fuel is to be supplied to the gaseous fuel control chamber and the spring chamber, wherein the liquid fuel pressure is based on the determined injection rate shape;
delivering the liquid fuel to the gaseous fuel control chamber and the spring chamber, at the determined liquid fuel pressure to achieve the determined injection rate shape; and
lifting the gaseous fuel needle check to inject the gaseous fuel based on the determined injection rate shape.
